(19) United States
(12) Patent Application Publication
(10) Pub. No.: US 2017/0347008 A1
(43) Pub. Date: Nov. 30, 2017

(54) METHOD FOR ADAPTING A BRIGHTNESS OF A HIGH-CONTRAST IMAGE AND CAMERA SYSTEM

(71) Applicant: CONNAUGHT ELECTRONICS LTD., Tuam, County Galway (IE)

(72) Inventors: Mark Patrick GRIFFIN, Tuam, County Galway (IE); Brian Michael Thomas DEEGAN, Tuam, County Galway (IE); Naveen KURUBA, Tuam, County Galway (IE)

(73) Assignee: Connaught Electronics Ltd., Tuam, County Galway (IE)

(21) Appl. No.: 15/534,302

(22) PCT Filed: Dec. 7, 2015
(86) PCT No.: PCT/EP2015/078764

§ 371 Date: Jun. 8, 2017

(30) Foreign Application Priority Data
Dec. 10, 2014 (DE) 10 2014 118 314.2

(51) Int. Cl. H04N 5/235; G06T 5/40; B60R 1/00; H04N 5/355; H04N 5/247; G06T 5/00; G06T 5/50

(52) U.S. Cl. CPC H04N 5/2355; H04N 5/2351; G06T 5/008; G06T 5/40; G06T 5/50; H04N 5/35545; H04N 5/247; B60R 1/00; H04N 5/2353; B60R 2300/30; G06T 2207/10004; G06T 2207/20208; G06T 2207/30252; G06T 2207/10024

(57) ABSTRACT

The invention relates to a method for adapting a brightness (28) of a high-contrast image (20, 22) of an environmental region (9) of a motor vehicle (1) including the following steps of: a) capturing a first image with a first camera parameter of a camera system (2) of the motor vehicle (1) and a second image with a second camera parameter of the camera system (2) by means of the camera system (2), b) generating a first high-contrast image (20) of the environmental region (9) with the first image and the second image, c) determining a high-contrast brightness value (23) of the first high-contrast image (20), d) comparing the high-contrast brightness value (23) to a predetermined high-contrast target brightness value, e) adapting the first high-contrast image (20) depending on the comparison according to step d), f) determining a first brightness value of the first image and/or a second brightness value of the second image, g) comparing the first brightness value to a first target brightness value (26) and/or the second brightness value to a second target brightness value (27), h) adapting the first camera parameter and/or the second camera parameter depending on the comparison according to step g), i) capturing a third image of the environmental region (9) with the adapted first camera parameter and a fourth image of the environmental region (9) with the adapted second camera parameter by means of the camera system (2), j) generating a second high-contrast image (22) of the environmental region (9) with the third image and the fourth image, k) providing the second high-contrast image (22) as a high-contrast image (20, 22) adapted in brightness for representing the environmental region (9) of the motor vehicle (1).

The invention relates to a method for adapting a brightness of a high-contrast image of an environmental region of a motor vehicle, in which a first image is captured with a first camera parameter of a camera system of the motor vehicle and a second image is captured with a second camera parameter of the camera system by means of the camera system. A first high-contrast image of the environmental region is generated with the first image and the second image, and a high-contrast brightness value of the first high-contrast image is determined. Furthermore, the high-contrast brightness value is compared to a predetermined high-contrast target brightness value, and the first high-contrast image is adapted depending on the comparison. The invention also relates to a camera system for a motor vehicle as well as to a motor vehicle with a camera system.

Methods for adapting a brightness of a high-contrast image are known from the prior art. The high-contrast image (HDRI—high dynamic range image) is a digital image reproducing great brightness differences rich in detail. The high-contrast image can for example be captured by HDR special cameras (HDR—high dynamic range), be artificially generated as 3D computer graphics or be reconstructed from an exposure series of photos with low dynamic range (LDR—low dynamic range). The exposure series of photos with low dynamic range includes at least two images. A first image is captured with a low exposure time and by a light-insensitive sensor to capture the bright areas in an environmental region. A second image is captured with a long exposure time and by a light-sensitive sensor to capture the dark areas in the environmental region. For example, multiple images can also be captured with camera parameters or camera settings, which are between the camera parameters of the first image and the second image. Finally, the high-contrast image is generated from the captured images. The high-contrast image usually has a higher bit depth than the images if the high-contrast image has not been reduced in its bit depth by a tone mapping method.

Thus, the basic principle of the high-contrast image is that a greater range of values or more brightness stages are available to capture the environmental region or the scene. Thus, with a conventional LDR capture, it is widespread to use 8 bits, thus 256 brightness stages or intensity values for each color channel of the image. Now, the entire brightness information thus has to be described by 256 intensity values. Meanwhile, in the high-contrast image, the entire brightness information of the scene is divided to the range of values of multiple images. Thus, for example, as already described above, the first image is captured from the dark part of the entire brightness range and the second image is captured from the bright part of the entire brightness range.

The brightness of the high-contrast image is now for example adapted based on the histogram of the high-contrast image. The histogram designates the graphic representation of the brightness value distribution or of the tone value distribution of the high-contrast image. Thus, the histogram is virtually image statistics indicating how frequently which brightness value is present in the image. The histogram can be determined for each color channel of the high-contrast image. Presently, the interest is in particular directed to a luminance channel of the high-contrast image, thus for example a Y channel of a YUV color model. However, the adaptation of the brightness can similarly be performed with other color channels in analogous manner.

The adaptation of the high-contrast image based on the histogram is disadvantageous in that severe adaptation of the brightness is usually only possible if a so-called clipping is accepted. In the clipping, the histogram is shifted as far as multiple brightness values have to be combined to a brightness value at the end of the range of values of the high-contrast image. The clipping therefore deteriorates the quality of the high-contrast image.

Especially in the capture of images of an environmental region of a motor vehicle, the disadvantages are essential since the detail realness suffers with these contrast differences—for example of bright sky to dark roadway surface—and thereby the recognition and further processing of relevant image information is aggravated. Thereby, the functionality of a driver assistance system operating based on the image information can also be restricted.

It is the object of the invention to provide a method, a camera system as well as a motor vehicle, by which or in which a high-contrast image of a motor vehicle environmental region adapted in brightness can be provided with a high contrast quality.

According to the invention, this object is solved by a method, by a camera system as well as by a motor vehicle having the features according to the respective independent claims.

In a method according to the invention for adapting a brightness of a high-contrast image of an environmental region of a motor vehicle, the following steps are performed:
a) capturing a first image with a first camera parameter of a camera system of the motor vehicle and a second image with a second camera parameter of the camera system by means of the camera system,
b) generating a first high-contrast image of the environmental region with the first image and the second image,
c) determining a high-contrast brightness value of the first high-contrast image,
d) comparing the high-contrast brightness value to a predetermined high-contrast target brightness value,
e) adapting the first high-contrast image depending on the comparison according to step d).
According to the Invention, the Following Steps are Performed:
f) determining a first brightness value of the first image and/or a second brightness value of the second image,
g) comparing the first brightness value to a first target brightness value and/or the second brightness value to a second target brightness value,
h) adapting the first camera parameter and/or the second camera parameter depending on the comparison according to step g),
i) capturing a third image of the environmental region with the adapted first camera parameter and a fourth image of the environmental region with the adapted second camera parameter by means of the camera system,
j) generating a second high-contrast image of the environmental region with the third image and the fourth image,
k) providing the second high-contrast image as a high-contrast image adapted in brightness for representing the environmental region of the motor vehicle.

By the method according to the invention, it becomes possible to adapt the brightness of the high-contrast image over a great brightness range and to prevent quality losses at the same time. Thus, it can for example be that the adaptation in step e) is only possible to a certain extent without clipping having to be performed and/or the brightness values of the first high-contrast image having to be shifted as far as the quality of the first high-contrast image substantially deteriorates.

The high-contrast target brightness value can also be referred to as YUV log target value.

The adaptation in step e) is preferably performed in a logarithmic range. To this, in the comparison according to step d), for example, the difference between the high-contrast brightness value and the predetermined high-contrast target brightness value is determined. The high-contrast brightness value can for example be an average brightness value of the first high-contrast image, thus the arithmetic mean or the median or else be determined based on a weighting function, which provides certain areas of the first high-contrast image with priorities to determine the high-contrast brightness value. The high-contrast brightness value of the first high-contrast image can for example also be determined only in a partial area of the first high-contrast image. The adaptation of the first high-contrast image in step e) is thus for example effected in the logarithmic range and can be effected by shifting the histogram of the first high-contrast image.

As a step essential to invention, it is provided that the first brightness value is determined from the first image and/or the second brightness value is determined from the second image. The determination of the first brightness value and/or the second brightness value can for example be effected by the arithmetic mean or the median or a weighting function prioritizing certain areas of the first image and/or the second image. The first brightness value and/or the second brightness value can for example also be determined only from a partial area of the first image and/or the second image. Preferably, the partial area for determining the first brightness value and/or the second brightness value is centrally disposed in the first image and/or the second image. However, the first brightness value and/or the second brightness value can for example also be determined from multiple, locally non-contiguous partial areas of the first image and/or of the second image. Depending on the first brightness value and/or the second brightness value, in step h), the first camera parameter and/or the second camera parameter are adapted. The first camera parameter and/or the second camera parameter can for example be an exposure time and/or a light sensitivity of a sensor of the camera system. With the adapted camera parameters, now, the third image and the fourth image can be captured subsequent in time with respect to the first image and the second image. Due to the adaptation of the camera parameters in step h), the third image and/or the fourth image are closer to a desired brightness than the first image and/or the second image. The temporal distance between the step a) and the step i) is in particular as short as possible and can for example correspond to a thirtieth of a second. With a motion of the camera system by the moving motor vehicle, thus, an at least similar environmental region is captured in the step a) and step i). Thus, a similar brightness in the environmental region to the location of the camera system in step a) and in step i) can substantially also be assumed.

In particular, the first image and the second image or the third image and the fourth image are also captured consecutively in time if the camera system is configured as an LDR camera system. However, if the camera system is for example configured as an HDR camera system, thus, the first image and the second image or the third image and the fourth image can be simultaneously provided or captured.

The second high-contrast image generated in step j), which is generated after the first high-contrast image in time, can be provided with a brightness by adapting the camera parameters in step h), which is closer to a desired brightness than the brightness of the first high-contrast image. In addition, the second high-contrast image can for example be adapted analogously to the steps c) to e), wherein the adaptation there is now in particular less extensively required and thus the quality of the second high-contrast image remains high.

The first target brightness value can for example be referred to as long channel target and the second target brightness value can for example be referred to as short channel target. Thus, the first target brightness value is for example used to adapt the first camera parameters, namely such that the first camera parameter is for example configured for bright areas of the environmental region. While the second camera parameter is adapted depending on the second target brightness and for example dark areas of the environmental region are captured with the second camera parameter and provided for the second high-contrast image.

Preferably, it is provided that the first camera parameter and/or the second camera parameter are characterized by an exposure time parameter of the camera system and/or a light sensitivity parameter of the camera system. By the exposure time parameter, it is determined how long an aperture of the camera system is opened and thus how much light or how much photons are incident on the sensor of the camera system. The exposure time parameter can for example be at an exposure time of the sensor of a thousandth of a second. The light sensitivity parameter can be described by an ISO value. The light sensitivity parameter describes, which gain or attenuation is executed in the sensor with respect to the incident number of the photons from the environmental region. If the light sensitivity parameter is set high, thus, few photons are sufficient to get into the intensity value range provided by the sensor. If the light sensitivity parameter is set low, thus, more photons than with the light sensitivity parameter set low are required to get into the intensity value range provided by the sensor. If more photons are incident on the sensor than it is provided by the light sensitivity parameter, thus, over-exposure occurs. If less photons from the environmental region are incident on the sensor than it is provided by the set range of values of the sensor, thus, under-exposure of the image occurs. By the exposure time parameter and/or the light sensitivity parameter, the first camera parameter and/or the second camera parameter can be adapted to the lighting conditions in the environmental region in optimum manner.

In particular, it is provided that a further high-contrast brightness value is determined from the second high-contrast image, and the second high-contrast image is adapted depending on a comparison to the further high-contrast brightness value and the high-contrast target brightness value according to step e). The further high-contrast brightness value is determined analogously to the high-contrast brightness value. To this, the second high-contrast image can for example be determined by the arithmetic mean or the median or a function weighting the brightness values or intensity values of the luminance color channel. By adapting the second high-contrast image according to step e), the brightness of the second high-contrast image can be provided adapted or approached to a desired brightness value in addition to the adaptation of the brightness due to the adapted camera parameters according to step h). The further high-contrast brightness value is therefore compared to the high-contrast target brightness value or the YUV log target value.

In a further embodiment, it is preferably provided that the adaptation according to step e) is characterized by shifting the histogram of the first high-contrast image. The brightness of the first high-contrast image and/or the second high-contrast image is thus preferably performed by shifting or manipulating the histogram of the first high-contrast image and/or the second high-contrast image. In particular, the manipulation of the histogram is carried out in a logarithmic space, in which the brightness values of the first high-contrast image and/or the second high-contrast image are represented on a logarithmic scale. Thus, the adaptation according to step e) can thereby be effected in effective manner.

Furthermore, it is preferably provided that the adaptation according to step e) is restricted by a lower brightness variation limit value and/or an upper brightness variation limit value. Thus, by the lower brightness variation limit value and/or the upper brightness variation limit value, a deterioration of the quality of the first high-contrast image and/or the high-contrast image adapted in brightness can be reduced or suppressed. Thus, the histogram is for example performed only up to certain values characterized by the lower brightness variation limit value and/or the upper brightness variation limit value. The adaptation of the brightness according to step e) is therefore limited in its effect, but clipping can for example be prevented thereby, and the adapted first high-contrast image can be provided with higher quality than if the lower brightness variation limit value and/or the upper brightness variation limit value would not be present.

Furthermore, it is preferably provided that the first camera parameter and/or the second camera parameter are only adapted in step h) if the first high-contrast image is not completely adapted to the high-contrast target brightness value due to the lower brightness variation limit value and/or the upper brightness variation limit value. Thus, it is preferably provided that the adaptation according to step h) is performed if the first high-contrast image and/or the second high-contrast image are not completely, thus not desirably, adapted to the high-contrast target brightness value. However, it is in particular provided that if the adaptation according to step e) depending on the lower brightness variation limit value and/or the upper brightness variation limit value was successful, thus the desired brightness value is achieved, thus, the adaptation of the first camera parameter and/or the second camera parameter can be omitted. Thus, computational effort can for example be avoided and the second high-contrast image can be more effectively provided.

In a further embodiment, it is in particular provided that at the same time with the second high-contrast image, at least one further second high-contrast image is generated according to steps a) to j), and an overall high-contrast image, in particular a plan view high-contrast image of the environmental region, is generated from the two second high-contrast images. Thus, a plurality of second high-contrast images can for example be generated according to steps a) to j), which finally are added to the overall high-contrast image. The adaptation of the brightness is then in particular effected such that the overall high-contrast image is homogenously represented, thus a brightness distribution as uniform as possible is present in the second high-contrast image and in the further second high-contrast image. By the top view high-contrast image, the environmental region of the motor vehicle can for example be output on a display device of the motor vehicle to allow a plan view of the environmental region of the motor vehicle to a user, in particular to the driver of the motor vehicle. The plan view high-contrast image is in particular useful in case the user is to be assisted in a parking procedure.

Furthermore, it is preferably provided that the brightness of the second high-contrast image and the further second high-contrast image is further adapted until a predetermined target homogeneity value of the brightness of the second high-contrast image and the further second high-contrast image is achieved. By the predetermined target homogeneity value, a similarity of the brightness of the second high-contrast image and the brightness of the further second high-contrast image is described. The target homogeneity value thus describes how similar the second high-contrast image and the further second high-contrast image are to be with respect to their brightness. The brightness can for example be determined in the same way as the high-contrast brightness value. This would imply that the brightness is for example determined or decided via an arithmetic mean or via the median or via a weighting function or via a weighting function of partial areas of the overall high-contrast image. Preferably, it is intended that the brightness of the overall high-contrast image seems to be uniformly distributed to a human eye. Thus, the user in particular is not to be confused upon viewing the overall high-contrast image by different, unnaturally appearing brightness areas.

In a further embodiment, it can be provided that the high-contrast target brightness value is determined depending on the target homogeneity value. Thus, it is for example first determined, which homogeneity is desired or demanded or required for the overall high-contrast image to subsequently set the high-contrast target brightness value for the respective high-contrast image in consequence. By determining the high-contrast target brightness value depending on the target homogeneity value, the high-contrast target brightness value and thus the brightness of the high-contrast image can be effectively adapted. By the effective adaptation, the respective high-contrast image can be provided for example such that the overall high-contrast image is closer to the target homogeneity value and thus corresponds better to the desired homogeneity.

Furthermore, it is preferably provided that the first high-contrast image and the second high-contrast image are generated as a component of an image sequence. In particular, the first high-contrast image is temporally disposed before the second high-contrast image in the image sequence. The image sequence can for example provide high-contrast images with 30 high-contrast frames per second. In particular, it is provided that the second high-contrast image is arranged directly after the first high-contrast image in the image sequence. The environmental region, from which the first high-contrast image is provided, thus only differs by a fraction of a second from the environmental region provided by the second high-contrast image. Thus, the lighting condition of the environmental region for the first high-contrast image only slightly differs from the lighting condition of the environmental region for the second high-contrast image. Thus, it is advantageous that the camera parameters, thus the first camera parameter and/or the second camera parameter, can be determined for the second high-contrast image depending on the images for the first high-contrast image for capturing the images.

In a further embodiment, it is provided that the first brightness value and/or the second brightness value and/or the high-contrast brightness value are determined depending on a weighting function. Thus, it can for example be provided that the intensity values of the first image and/or the second image and/or the third image and/or the fourth image and/or the first high-contrast image and/or the second high-contrast image are combined to the first brightness value or the second brightness value or the high-contrast brightness value in weighted manner. For example, an intensity value in the center of the image can be more severely weighted than an intensity value at the edge of the image. Additionally or alternatively, for example, only a partial area of the image can also be used to determine the first brightness value and/or the second brightness value and/or the high-contrast brightness value. Thus, the area can for example be disposed in a center of the image and there combine pixels or intensity values within a predetermined radius and provide the first brightness value and/or the second brightness value and/or the high-contrast brightness value by a single value. It is advantageous that the first brightness value and/or the second brightness value and/or the high-contrast brightness value can be provided by the weighting function such that the brightness of the respective image is precisely described. The precise description can for example be defined by a perception by the human eye.

In a further embodiment, it can be provided that in the capture of the first image and/or the second image and/or the third image and/or the fourth image, an aperture of the camera system is additionally adapted depending on the lighting conditions in the environmental region. Thus, for example, the light sensitivity and/or the exposure time is characterized by the first camera parameter and/or the second camera parameter, while in addition to the adaptation according to step h) the aperture of the camera system can be adapted. With a small aperture, less light or less photons from the environmental region arrive at the sensor, and with large aperture, more photons from the environmental region arrive at the sensor. Thus, the brightness of the image can also be influenced by the aperture. By the aperture, the first image and/or the second image and/or the third image and/or the fourth image can therefore be even more precisely captured with respect to the lighting conditions in the environmental region by the camera system.

The invention also relates to a camera system for a motor vehicle with at least one camera, wherein the camera system is adapted to perform a method according to the invention. To this, the camera system can also include at least one evaluation unit, which is formed for performing the method steps. The evaluation unit can be a component of the camera or be formed as a unit separate from it.

In a further embodiment, the camera can be formed as an HDR camera, which is adapted to capture a first image with first camera parameters and a second image with second camera parameters at the same time. The special HDR camera can therefore provide a simultaneous capture of the first image and the second image in contrast to the conventional camera sequentially capturing the first image and the second image. The first high-contrast image can thus for example be faster generated from the first image and the second image if they are simultaneously captured. An image sequence with the first high-contrast image and a second high-contrast image can for example be more high-frequency provided.

A driver assistance system according to the invention includes a camera system according to the invention or an advantageous implementation thereof.

A motor vehicle according to the invention, in particular a passenger car, includes a camera system according to the invention or an advantageous implementation thereof.

The preferred embodiments presented with respect to the method according to the invention and the advantages thereof correspondingly apply to the camera system according to the invention as well as to the motor vehicle according to the invention.

Further features of the invention are apparent from the claims, the figures and the description of figures. The features and feature combinations mentioned above in the description as well as the features and feature combinations mentioned below in the description of figures and/or shown in the figures alone are usable not only in the respectively specified combination, but also in other combinations or alone, without departing from the scope of the invention. Thus, implementations are also to be considered as encompassed and disclosed by the invention, which are not explicitly shown in the figures and explained, but arise from and can be generated by separated feature combinations from the explained implementations. Implementations and feature combinations are also to be considered as disclosed, which thus do not have all of the features of an originally formulated independent claim.

Below, embodiments of the invention are explained in more detail based on schematic drawings.

There show:

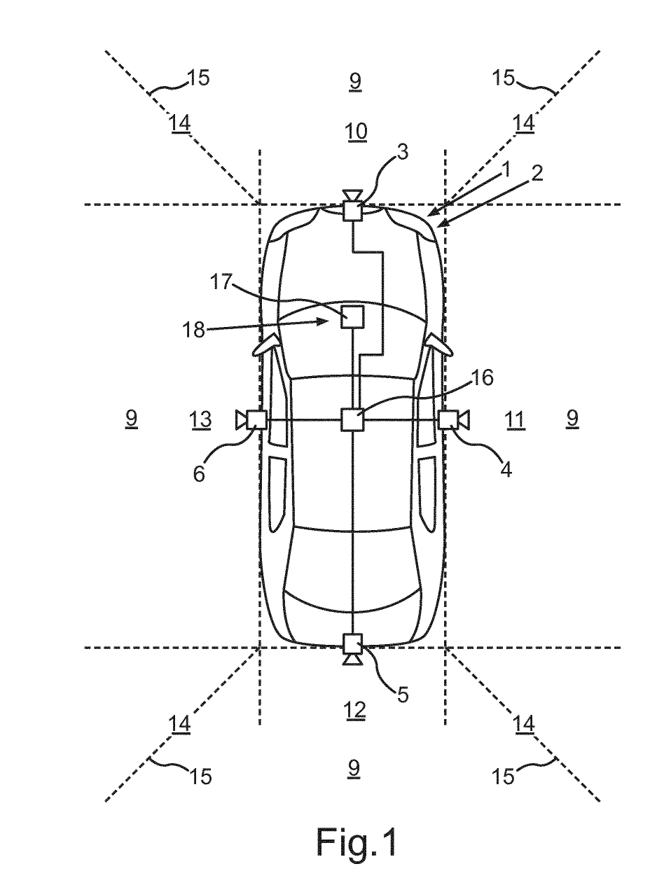

FIG. 1 in schematic plan view an embodiment of a motor vehicle according to the invention with a camera system;

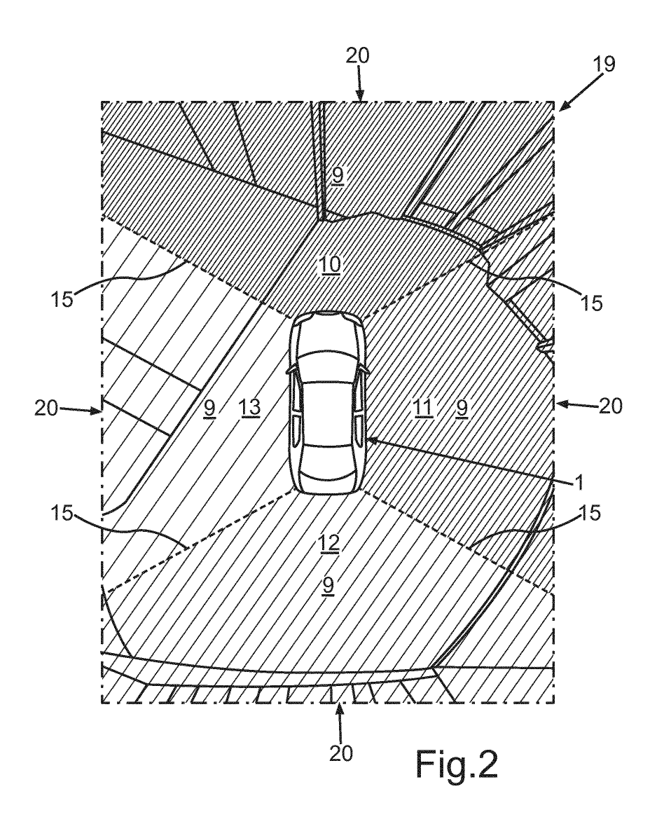

FIG. 2 a schematic illustration of a known plan view high-contrast image of the environmental region with heterogeneous high-contrast images;

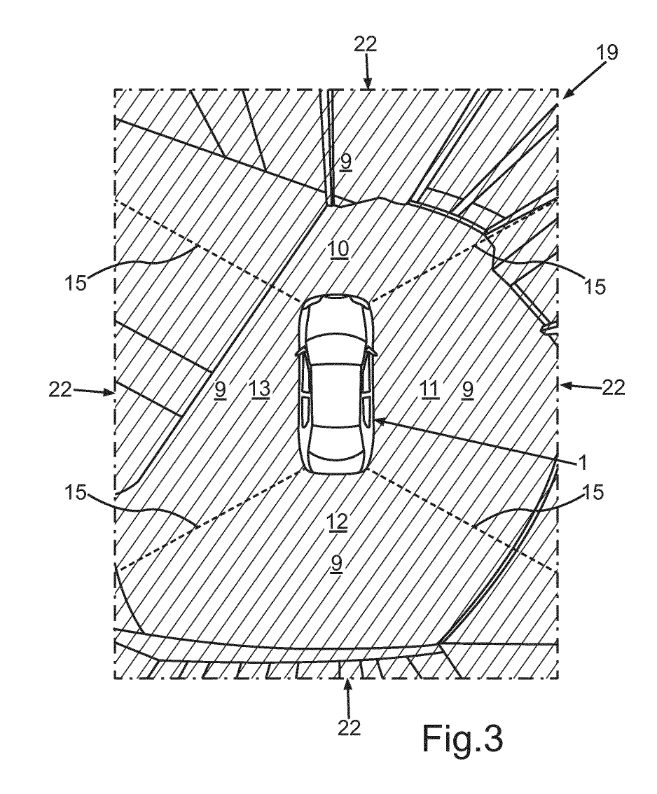

FIG. 3 a schematic illustration of an embodiment of a plan view high-contrast image of the environmental region adapted in brightness generated according to the invention with substantially homogenous high-contrast images;

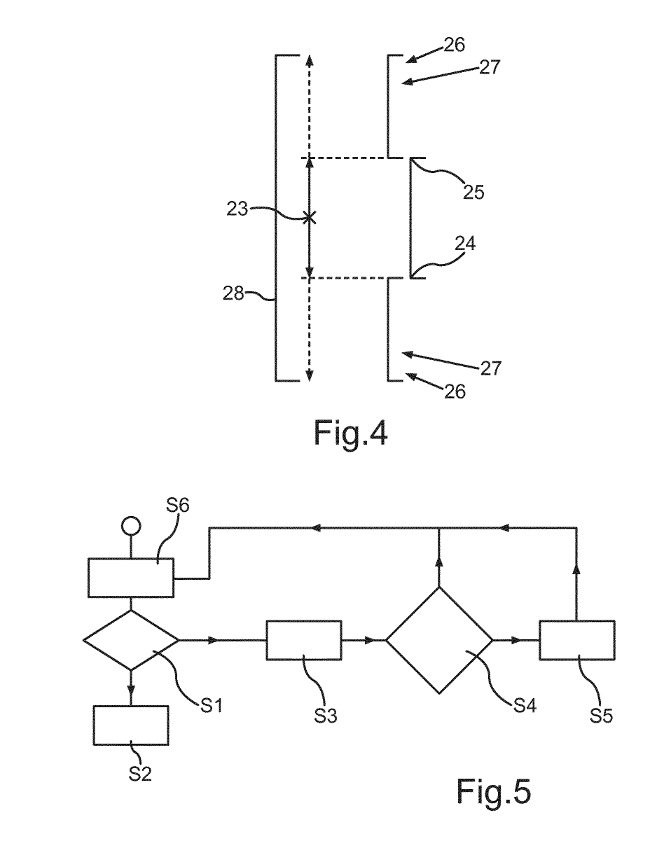

FIG. 4 a sketchy illustration of the adaptation of the brightness of the high-contrast image according to FIG. 3 of the environmental region with a high-contrast target brightness value, a first target brightness value and a second target brightness value; and

FIG. 5 a flow diagram for adapting a brightness of a high-contrast image of an environmental region of the motor vehicle.

In the figures, identical or functionally identical elements are provided with the same reference characters.

In FIG. 1, a plan view of a motor vehicle 1 with a camera system 2 or a camera device according to an embodiment of the invention is schematically illustrated. The camera system 2 can be encompassed by a driver assistance system or a driver assistance device of the motor vehicle 1. In the embodiment, the camera system 2 includes a first camera 3, a second camera 4, a third camera 5 and a fourth camera 6. According to the embodiment, the first camera 3 is disposed on a front 7 of the motor vehicle 1, and the third camera 5 is disposed on a rear 8 of the motor vehicle 1. The second camera 4 and the fourth camera 6 are each laterally disposed on the motor vehicle 1. However, the arrangement of the cameras 3, 4, 5, 6 is variously possible, however, preferably such that an environmental region 9 around the motor vehicle 1 can be captured.

The first camera 3 captures a first partial area 10 of the environmental region 9, the second camera 4 captures a second partial area 11 of the environmental region 9, the third camera 5 captures a third partial area 12 of the environmental region 9 and the fourth camera 6 captures a fourth partial area 13 of the environmental region 9. The partial areas 10, 11, 12, 13 overlap in overlap areas 14, which are respectively disposed where partial areas 10, 11, 12, 13 directly adjoin each other. The overlap areas 14 can for example be divided by overlap area separating lines 15. Based on the overlap area separating lines 15, it can for example be determined, which of the partial areas 10, 11, 12, 13 is to be displayed in the motor vehicle 1.

The camera system 2 further includes at least one evaluation unit 16 and a display unit 17. The evaluation unit 16 is disposed centrally in the motor vehicle 1 according to the embodiment. However, the arrangement of the evaluation unit 16 is variously possible, for example, the evaluation unit 16 can be integrated in the camera 3, 4, 5, 6 or be formed as a separate unit. Multiple evaluation units 16 can for example also be provided. The display unit 17 is for example a screen. The screen can for example be formed as an LCD screen. According to the embodiment, the display unit 17 is disposed on a center console 18 of the motor vehicle 1. However, the arrangement of the display unit 17 is variously possible in the motor vehicle 1, however preferably such that a user, in particular the driver of the motor vehicle 1, has an unobstructed view to the display unit 17.

According to the embodiment, the partial areas 10, 11, 12, 13 are output on the display unit 17 for example via the evaluation unit 16.

FIG. 2 shows a known plan view high-contrast image 19 as it is provided in the prior art. The known plan view high-contrast image 19 is generated from four first high-contrast images 20. The first high-contrast images 20 are assembled to the known plan view high-contrast image 19. The boundary between the assembled first high-contrast images 20 is marked by the overlap area separating lines 15. By the known plan view high-contrast image 19, the environmental region 9 of the motor vehicle 1 can be presented on the display unit 17. This can for example be helpful in a parking procedure for a user of a motor vehicle. However, the known plan view high-contrast image 19 is disadvantageous in that the brightness of the first high-contrast images 20 is different. Thereby, a severe gradient or a severe brightness decrease or brightness increase unpleasant to the human eye arises thereby in particular at the overlap area separating lines 15. The consequence is that the known plan view high-contrast image 19 seems non-homogenous or heterogeneous to the human eye.

FIG. 3 shows a plan view high-contrast image 21 adapted according to an embodiment of the invention. The plan view high-contrast image 21 is generated from four second high-contrast images 22—according to the embodiment. The second high-contrast images 22 are further adapted with respect to their brightness than it is the case in the first high-contrast images 20. FIG. 3 thus shows the plan view high-contrast image 21, which is more homogenous with respect to the brightness or the brightness distribution than the known plan view high-contrast image 19. In particular, the plan view high-contrast image 21 is in particular homogenous or free of brightness gradients in the area of the overlap area separating lines 15. In the plan view high-contrast image 21, thus, severe brightness variations in the area of the overlap area separating lines 15 unpleasant to the human eye in particular do not arise. The brightness of the second high-contrast images 22 is preferably determined based on a target homogeneity value of the brightness of the second high-contrast images 22.

FIG. 4 shows a scheme according to an embodiment according to the invention with a high-contrast brightness value 23, which is determined from the first high-contrast image 20. The determination of the high-contrast brightness value 23 can for example be effected with an arithmetic mean or a weighting function. The high-contrast brightness value 23 can also be determined only in certain areas in the first high-contrast image 20. The high-contrast brightness value 23 is in particular a scalar. A brightness 28 of the first high-contrast image 20 is adapted within a lower brightness variation limit value 24 and an upper brightness variation limit value 25. The adaptation is for example effected based on the histogram of the first high-contrast image 20. Thus, the brightness 28 of the high-contrast image 20, 22 can be adapted. The brightness 28 can be adapted by the first target brightness value and/or the second target brightness value and the consequent adaptation of the first camera parameter and/or the second camera parameter via the boundaries of the lower brightness variation limit value 24 and/or the upper brightness variation limit value 25. The brightness 28 is preferably adapted via a luminance channel of the high-contrast image 20, 22. The luminance channel can for example be described by the Y channel in a YUV color model. However, the first image and/or the second image and/or the third image and/or the fourth image and/or the first high-contrast image 20 and/or the second high-contrast image 22 can for example also be present in another color model such as an RGB color model.

FIG. 5 shows an exemplary flow diagram of the invention for adapting the brightness 28 of the first high-contrast image 20. In a step S1, based on the target homogeneity value of the brightness 28 of the second high-contrast images 22, it is determined if the first high-contrast image 20 is adapted with respect to the brightness 28. If the brightness 28 of the first high-contrast image 20 matches with respect to the target homogeneity value, thus, the first high-contrast image 20 is displayed or output on the display unit 17 as the second high-contrast image 22 in the plan view high-contrast image 21 with a step S2. If the target homogeneity value is not yet satisfied by the first high-contrast image 20, thus, the first high-contrast image 20 is adapted depending on a high-contrast target brightness value in a step S3. To this, a high-contrast brightness value is determined from the first high-contrast image 20, which is compared to the high-contrast target brightness value or a YUV log target value. Depending on the comparison, the first high-contrast image 20 is adapted with respect to the brightness 28. The first high-contrast image 20 is preferably in a YUV color model, and preferably the luminance channel, thus the Y channel, of the first high-contrast image 20 is adapted. However, the adaptation in step S3 is restricted by the lower brightness variation limit value 24 and the upper brightness variation limit value 25 in the amount of the brightness adaptation. This means that the brightness 28 of the first high-contrast image 20 can only be adapted within the limits of the lower brightness variation limit value 24 and the upper brightness variation limit value 25. In a step S4, it is determined if the adaptation of the first high-contrast image 20 within the lower brightness variation limit value 24 and the upper brightness variation limit value 25 was sufficient to satisfy the criterion of the target homogeneity value. If the criterion of the target homogeneity value can be satisfied by the adaptation in step S3, thus, a step S6 follows, in which the high-contrast brightness value 23 in context of step S1 is compared to the target homogeneity value to homogenously integrate the first high-contrast image 20 in the plan view high-contrast image 21 as the second high-contrast image 22. If the adaptation of the first high-contrast image 20 in step S3 does not satisfy the target homogeneity value, thus, subsequent to step S4, a further adaptation of the brightness 28 of the first high-contrast image 20 is performed. Thus, in a step S5, a first camera parameter and a second camera parameter are adapted. The first high-contrast image 20 is generated with a first image and a second image. The first image is captured with the first camera parameters and the second image is captured with the second camera parameters. If it is now determined in step S4 that the first high-contrast image 20 cannot be further adapted with respect to the brightness 28 due to the lower brightness variation limit value 24 and/or the upper brightness variation limit value 25, thus, the first camera parameter and/or the second camera parameter are accordingly adapted in the temporally subsequent capturing process. Thus, for the second high-contrast image 22, which is provided after the first high-contrast image 20 in time, a third image and a fourth image are captured to generate the second high-contrast image 22. For the third image and the fourth image, the adapted first camera parameter and the adapted second camera parameter are used. By adapting the first camera parameter and/or the second camera parameter, thus, the second high-contrast image 22 can satisfy the high-contrast target brightness value 23 in step S2 in a next passage of the flow diagram of FIG. 5, or otherwise the adaptation in step S3 can be allowed without the adaptation being restricted by the lower brightness variation limit value 24 and/or the upper brightness variation limit value 25.

The first high-contrast image 20 and/or the second high-contrast image 22 are preferably characterized by 20 bits with respect to their bit depth.

The cameras 3, 4, 5, 6 can be CMOS (complementary metal-oxide-semiconductor) cameras or else CCD (charge-coupled device) cameras or else special HDR cameras. The cameras 3, 4, 5, 6 are in particular video cameras, which continuously provide an image sequence. The special HDR camera can simultaneously provide the first image and the second image or the third image and the fourth image. With the camera 3, 4, 5, 6 as a conventional LDR camera, the third image and the fourth image or the first image and the second image are in particular consecutively captured.

The first camera parameter and the second camera parameter are in particular characterized by an exposure time parameter of the camera 3, 4, 5, 6 and/or a light sensitivity parameter of the camera 3, 4, 5, 6. Thus, it can thereby be responded to the lighting conditions in the environmental region 9 for the third image and the fourth image due to the experience from the first image and the second image. The first camera parameter and/or the second camera parameter are therefore correspondingly adapted to the lighting conditions of the environmental region 9. The first image and the second image and the third image and the fourth image are provided within a fraction of a second, whereby a variation of the lighting conditions in the environmental region 9 occurs only to a limited extent and the effects thereof can therefore be tolerated.

Preferably, before displaying the plan view high-contrast image 21 on the display unit 17, a tone mapping method is performed to reduce the plan view high-contrast image 21 with respect to its bit depth, in particular to 8 bits for each color channel of the plan view high-contrast image 21.

1. A method for adapting a brightness of a high-contrast image of an environmental region of a motor vehicle comprising:
a) capturing a first image with a first camera parameter by a first camera of a camera system of the motor vehicle and a second image with a second camera parameter by a second camera of the camera system;
b) generating a first high-contrast image of the environmental region with the first image and the second image;
c) determining a high-contrast brightness value of the first high-contrast image;
d) comparing the high-contrast brightness value to a predetermined high-contrast target brightness value;
e) adapting the first high-contrast image depending on the comparison according to step d);
f) determining a first brightness value of the first image and/or a second brightness value of the second image;
g) comparing the first brightness value to a first target brightness value and/or the second brightness value to a second target brightness value;
h) adapting the first camera parameter and/or the second camera parameter depending on the comparison according to step g;
i) capturing a third image of the environmental region with the adapted first camera parameter and a fourth image of the environmental region with the adapted second camera parameter by means of the camera system;
j) generating a second high-contrast image of the environmental region with the third image and the fourth image; and
k) providing the second high-contrast image as a high-contrast image adapted in brightness for representing the environmental region of the motor vehicle.

2. The method according to claim 1, wherein the first camera parameter and/or the second camera parameter are characterized by an exposure time parameter of the camera system and/or a light sensitivity parameter of the camera system.

3. The method according to claim 1, wherein a further high-contrast brightness value is determined from the second high-contrast image, and the second high-contrast image is adapted depending on a comparison to the further high-contrast brightness value and the high-contrast target brightness value according to step e).

4. The method according to claim 1, wherein in that the adaptation according to step e) is characterized by shifting the histogram of the first high-contrast image.

5. The method according to claim 1, wherein the adaptation according to step e) is restricted by a lower brightness variation limit value and/or an upper brightness variation limit value.

6. The method according to claim 5, wherein the first camera parameter and/or the second camera parameter are adapted in step h) only if the first high-contrast image is not completely adapted to the high-contrast target brightness value due to the lower brightness variation limit value and/or the upper brightness variation limit value.

7. The method according to claim 1, wherein at the same time with the second high-contrast image, at least one further second high-contrast image is generated according to steps a) to j), and an overall high-contrast image, a plan view high-contrast image of the environmental region, is generated from the two second high-contrast images.

8. The method according to claim 7, wherein the brightness of the second high-contrast image provided with step k) and the at least one further second high-contrast image is further adapted until a predetermined target homogeneity value of the brightness of the second high-contrast image and the further second high-contrast image is achieved.

9. The method according to claim 8, wherein the high-contrast target brightness value is determined depending on the target homogeneity value.

10. The method according to claim 1, wherein the first high-contrast image and the second high-contrast image are generated as a component of an image sequence.

11. method according to claim 1, wherein the first brightness value and/or the second brightness value and/or the high-contrast brightness value are determined depending on a weighting function.

12. The method according to claim 1, wherein in capturing at least one of the first image, and/or the second image, the third image and the fourth image, an aperture of the camera system is additionally adapted depending on the lighting conditions in the environmental region.

13. A camera system for a motor vehicle including at least one camera and at least one evaluation unit, which is adapted to perform a method according to claim 1.

14. The camera system according to claim 13, wherein the first and the second camera of the camera system are formed as an HDR camera.

15. A motor vehicle with a camera system according to claim 13.
